(19) United States
(12) Patent Application Publication
(10) Pub. No.: US 2025/0259389 A1
(43) Pub. Date: Aug. 14, 2025

(54) DELIVERING STORED OBJECTS FOR XR APPLICATIONS

(71) Applicant: QUALCOMM Incorporated, San Diego, CA (US)

(72) Inventors: Ning BI, San Diego, CA (US); Satheesh Kumar KARRA, San Diego, CA (US); Michel Adib SARKIS, San Diego, CA (US); Liangping MA, San Diego, CA (US); Nikolai Konrad LEUNG, San Francisco, CA (US)

(21) Appl. No.: 18/438,012

(22) Filed: Feb. 9, 2024

(51) Int. Cl. G06T 17/20; G06T 13/40; H04N 7/15

(52) U.S. Cl. CPC G06T 17/20; G06T 13/40; H04N 7/157

(57) ABSTRACT

This disclosure provides systems, devices, apparatus, and methods, including computer programs encoded on storage media, for delivering stored objects for XR applications. A processor transmits, to an object library, a query for supported forms of enroll data of an avatar of a second user, where the first device is associated with a first user and a second device is associated with the second user. The processor receives, from the object library and based on the query, a list of the supported forms of the enroll data. The processor transmits, to the second device, an identifier of a supported form in the list of the supported forms. The processor performs an avatar call with the second device based on the transmitted identifier of the supported form.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for extended reality (XR) may not address certain aspects of delivering stored objects to XR devices. There is a need for improved techniques pertaining to delivering stored objects to XR devices.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first device are provided. The apparatus includes a memory; and a processor coupled to the memory and, based on information stored in the memory, the processor is configured to: transmit, to an object library, a query for supported forms of enroll data of an avatar of a second user, where the first device is associated with a first user and a second device is associated with the second user; receive, from the object library and based on the query, a list of the supported forms of the enroll data; transmit, to the second device, an identifier of a supported form in the list of the supported forms; and perform an avatar call with the second device based on the transmitted identifier of the supported form.

In an aspect of the disclosure, a method, a computer-readable medium, and an apparatus at an object library are provided. The apparatus includes a memory; and a processor coupled to the memory and, based on information stored in the memory, the processor is configured to: receive, from a first device of a first user, a query for supported forms of enroll data of an avatar of a second user; transmit, to the first device and based on the query, a list of the supported forms of the enroll data; receive, from the first device, an identifier of a supported form in the list of the supported forms; and transmit, to the first device, the supported form, where the supported form is associated with an avatar call between the first device and a second device of the second user.

In an aspect of the disclosure, a method, a computer-readable medium, and an apparatus at a second device are provided. The apparatus includes a memory; and a processor coupled to the memory and, based on information stored in the memory, the processor is configured to: receive an identifier of a supported form in a list of supported forms of enroll data of an avatar of a second user, where the list of supported forms is associated with an object library, where the second device is associated with the second user; and perform an avatar call with a first device of a first user based on the received identifier of the supported form.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example image or surface in accordance with one or more techniques of this disclosure.

FIG. 4 is a diagram illustrating an example of delivering cloud stored objects for extended reality (XR) applications in accordance with one or more techniques of this disclosure.

FIG. 5 is a diagram illustrating a first example and a second example of a successful retrieval of a requested object in a reduced form in accordance with one or more techniques of this disclosure.

FIG. 6 is a diagram illustrating a first example and a second example of an unsuccessful retrieval of a requested object in a reduced form in accordance with one or more techniques of this disclosure.

FIG. 7 is a call flow diagram illustrating example communications between a first device, an object library, and a second device in accordance with one or more techniques of this disclosure.

FIG. 8 is a call flow diagram illustrating example communications between a first device, an object library, and a second device in accordance with one or more techniques of this disclosure.

FIG. 9 is a diagram illustrating a first example and a second example of an object library as a cache in accordance with one or more techniques of this disclosure.

FIG. 10 is a call flow diagram illustrating example communications between a first cache of a first device, a first application of the first device, a second cache of a second device, and a second application of the second device in accordance with one or more techniques of this disclosure.

FIG. 11 is a call flow diagram illustrating example communications between a first device, an object library, and a second device in accordance with one or more techniques of this disclosure.

FIG. 12 is a flowchart of an example method of graphics processing in accordance with one or more techniques of this disclosure.

FIG. 13 is a flowchart of an example method of graphics processing in accordance with one or more techniques of this disclosure.

FIG. 14 is a flowchart of an example method of graphics processing in accordance with one or more techniques of this disclosure.

FIG. 15 is a flowchart of an example method of graphics processing in accordance with one or more techniques of this disclosure.

FIG. 16 is a flowchart of an example method of graphics processing in accordance with one or more techniques of this disclosure.

FIG. 17 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

A first device and a second device may engage in an avatar call with one another. An avatar call may refer to a video call between a first device of a first user and a second device of a second user, where a first avatar of the first user is presented to the second user via the second device during the video call, and where a second avatar of the second user is presented to the first user via the first device during the video call. An avatar may refer to a graphical representation of a user, a character of the user, or a person of the user. Performing an avatar call may entail the exchange of certain data (e.g., enroll data). Enroll data may refer to data representing an avatar used in an avatar call. In some aspects, the enroll data may include a 3D mesh, a normal map, an Albedo map, and/or a specular map for a face. There may not be a well-defined mechanism for coordinating the exchange of such data. As a result, performing an avatar call may be associated with latency and computational burdens.

Various technologies pertaining to delivering stored objects for XR applications are described herein. In an example, an apparatus (e.g., a first device) transmits, to an object library, a query for supported forms of enroll data of an avatar of a second user, where the first device is associated with a first user and a second device is associated with the second user. The apparatus receives, from the object library and based on the query, a list of the supported forms of the enroll data. The apparatus transmits, to the second device, an identifier of a supported form in the list of the supported forms. The apparatus performs an avatar call with the second device based on the transmitted identifier of the supported form. Vis-à-vis transmitting the query for the supported forms of the enroll data and transmitting the identifier of the supported form, the apparatus may perform the avatar call in a manner that reduces latency and computational burdens.

In another example, an apparatus (e.g., an object library) receives, from a first device of a first user, a query for supported forms of enroll data of an avatar of a second user. The apparatus transmits, to the first device and based on the query, a list of the supported forms of the enroll data. The apparatus receives, from the first device, an identifier of a supported form in the list of the supported forms. The apparatus transmits, to the first device, the supported form, where the supported form is associated with an avatar call between the first device and a second device of the second user. Vis-à-vis transmitting the list of the supported forms and receiving the identifier of the supported form, the apparatus may facilitate performance of an avatar call between the first device and the second device in a manner that reduces latency and computational burdens.

In yet another example, an apparatus (e.g., a second device) receives an identifier of a supported form in a list of supported forms of enroll data of an avatar of a second user, where the list of supported forms is associated with an object library, where the second device is associated with the second user. The apparatus performs an avatar call with a first device of a first user based on the received identifier of the supported form. Vis-à-vis performing the avatar call based on the received identifier of the supported form, the apparatus may perform the avatar call in a manner that reduces latency and computational burdens.

In one aspect, XR application objects (e.g., three-dimensional (3D) meshes (e.g., for avatars, digital twins) and network weights) may be stored in a cloud in a reduced form (e.g., at a lower resolution, descriptive information (e.g., a number of vertices), a hash, an index, a file name, an identifier (ID), etc.). When an object is requested by Device A to send to Device B, the reduced form may be used to identify the object stored in the cloud. If a match is made, a communication can be made to Device B (either from Device A or the cloud) to enable the full version to be retrieved. Additionally, the object may be tagged with an ID of a session between Device A and Device B and/or the object may be put into a dedicated cache for faster retrieval.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

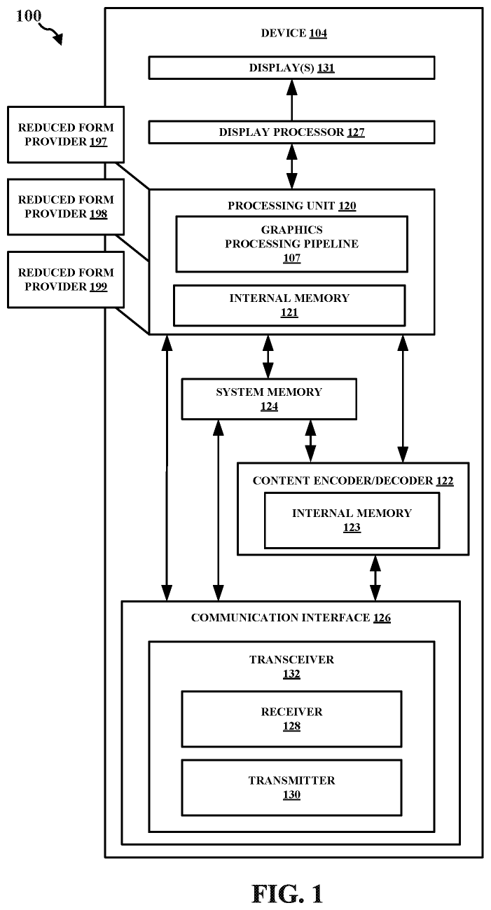

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit may include a reduced form provider 197 configured to transmit, to an object library, a query for supported forms of enroll data of an avatar of a second user, where the first device is associated with a first user and a second device is associated with the second user; receive, from the object library and based on the query, a list of the supported forms of the enroll data; transmit, to the second device, an identifier of a supported form in the list of the supported forms; and perform an avatar call with the second device based on the transmitted identifier of the supported form. In certain aspects, the processing unit may include a reduced form provider 198 configured to receive, from a first device of a first user, a query for supported forms of enroll data of an avatar of a second user; transmit, to the first device and based on the query, a list of the supported forms of the enroll data; receive, from the first device, an identifier of a supported form in the list of the supported forms; and transmit, to the first device, the supported form, where the supported form is associated with an avatar call between the first device and a second device of the second user. In certain aspects, the processing unit may include a reduced form provider 199 configured to receive an identifier of a supported form in a list of supported forms of enroll data of an avatar of a second user, where the list of supported forms is associated with an object library, where the second device is associated with the second user; and perform an avatar call with a first device of a first user based on the received identifier of the supported form. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

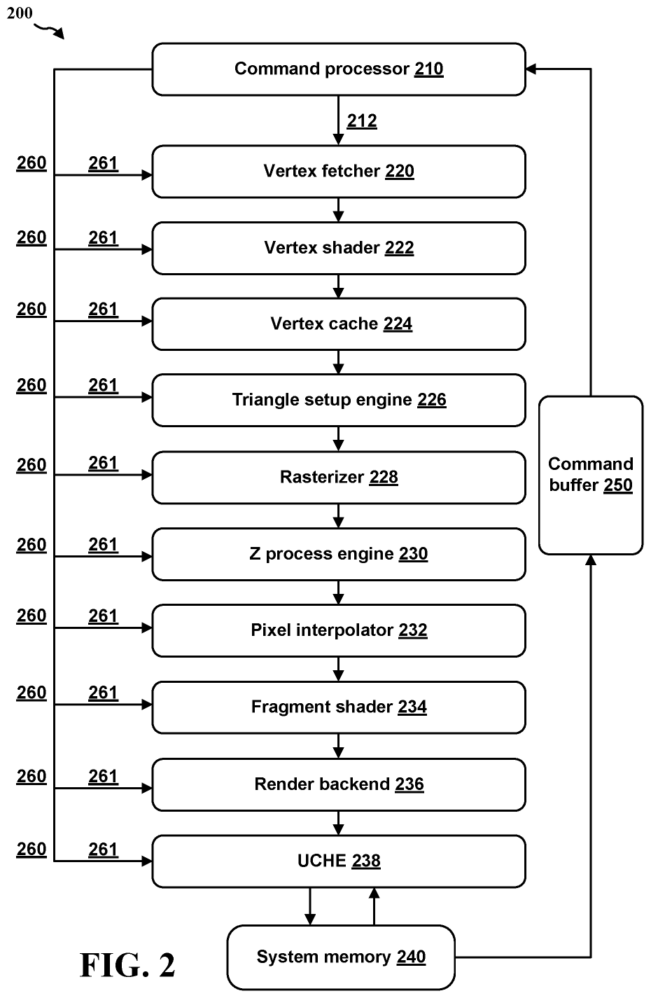

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

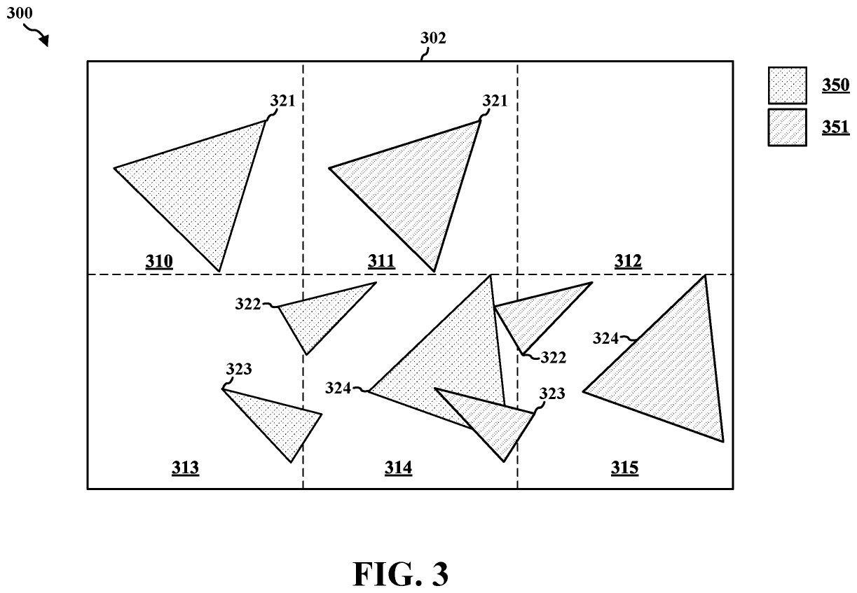

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

A user may wear a display device in order to experienced extended reality (XR) content. XR may refer to a technology that blends aspects of a digital experience and the real world. XR may include augmented reality (AR), mixed reality (MR), and/or virtual reality (VR). In AR, AR objects may be superimposed on a real-world environment as perceived through the display device. In an example, AR content may be experienced through AR glasses that include a transparent or semi-transparent surface. An AR object may be projected onto the transparent or semi-transparent surface of the glasses as a user views an environment through the glasses. In general, the AR object may not be present in the real world and the user may not interact with the AR object. In MR, MR objects may be superimposed on a real-world environment as perceived through the display device and the user may interact with the MR objects. In some aspects, MR objects may include “video see through” with virtual content added. In an example, the user may “touch” a MR object being displayed to the user (i.e., the user may place a hand at a location in the real world where the MR object appears to be located from the perspective of the user), and the MR object may “move” based on the MR object being touched (i.e., a location of the MR object on a display may change). In general, MR content may be experienced through MR glasses (similar to AR glasses) worn by the user or through a head mounted display (HMD) worn by the user. The HMD may include a camera and one or more display panels. The HMD may capture an image of environment as perceived through the camera and display the image of the environment to the user with MR objects overlaid thereon. Unlike the transparent or semi-transparent surface of the AR/MR glasses, the one or more display panels of the HMD may not be transparent or semi-transparent. In VR, a user may experience a fully-immersive digital environment in which the real-world is blocked out. VR content may be experienced through a HMD. XR and metaverse over the Internet may entail efficient rendering of images. In rendering images, bandwidth and latency may be correlated. Latency may cause problems rendering images, and hence technologies that reduce rendering may be utilized to improve an experience of a user in an XR application and/or in the metaverse. In one aspect pertaining to the metaverse of the Internet, a cloud server may host an image library which may be dynamically updated depending on a transmission and/or a reception environment of participants in the metaverse. The cloud server (i.e., the image library) may transmit a reduced resolution version of an image that may be used to compare against information in the image library. If a match is determined, the cloud server may retrieve and forward a full resolution version of the image for rendering the image and/or for generation of an avatar (e.g., a photorealistic avatar). In the event that there is not a match based on the comparison, a full resolution image may be caused to be transmitted to a receiver.

In one aspect presented herein, a framework for negotiating a reduced form of an object between a sender and an object library is described. In another aspect presented herein, a process for an image library sending a requested image to a user is described. In one aspect, an object may be a multimedia object, such as an image, a three-dimensional (3D) asset, a mesh, or a digital twin. In one aspect presented herein, a reduced form of an object may be a lower resolution version of an image or an output of a hash function performed on an image (or a portion thereof). In one aspect presented herein, an avatar may be an XR avatar.

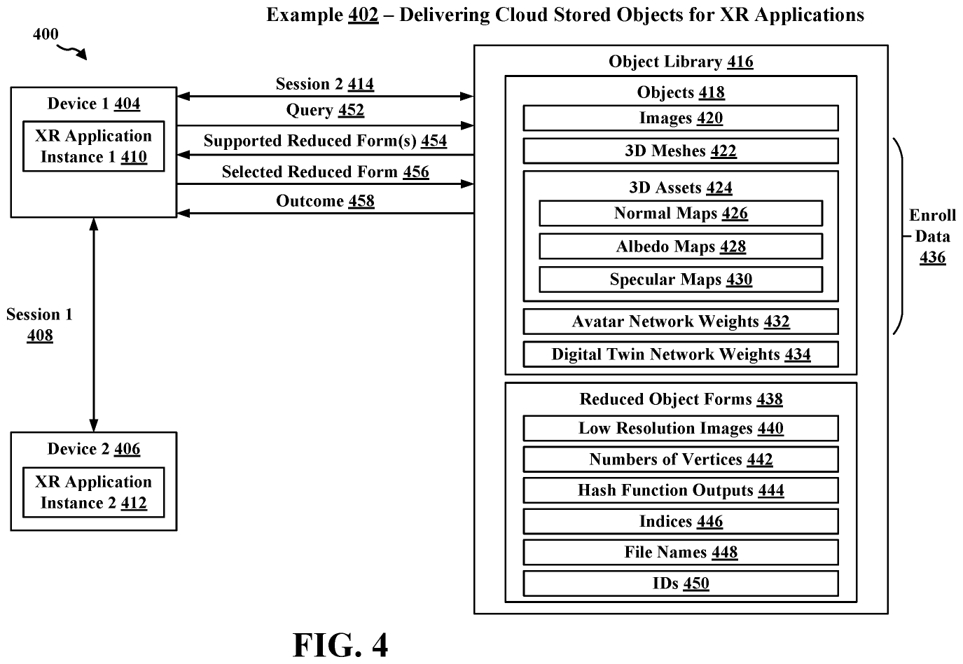

FIG. 4 is a diagram 400 illustrating an example 402 of delivering cloud stored objects for extended reality (XR) applications in accordance with one or more techniques of this disclosure. A first device 404 and a second device 406 may start a first session 408 (e.g., via a wireless link or a wired link) for an XR application. A session may refer to a channel in which two-way communication occurs. In an example, the XR application may be an avatar application, an AR application, a VR application (e.g., a VR call application), or a game. In an example, the first device 404 may be a first phone of a first user and the second device 406 may be a second phone of a second user. In an example, the XR application may be associated with a first XR application instance 410 and a second XR application instance 412. The first device 404 may execute the first XR application instance 410 and the second device 406 may execute the second XR application instance 412. In an example, the first device 404 may be or include the device 104. In an example, the second device 406 may be or include the device 104.

The first device 404 may start a second session 414 (e.g., via a wireless link or a wired link) with an object library 416. The object library 416 may alternatively be referred to as a multimedia object library or a library. In an example, the object library 416 may be a server, such as a cloud server or a data server. In another example, the object library 416 may be part of the server. For instance, the object library 416 may be data storage of the server. In one aspect, the object library 416 may be or include a plurality of data centers that store enroll data for avatars in an avatar call. In one aspect, the object library 416 may be part of the first device 404. For instance, the object library 416 may include a cache on the first device 404. An avatar call may refer to a video call between a first device of a first user and a second device of a second user, where a first avatar of the first user is presented to the second user via the second device during the video call, and where a second avatar of the second user is presented to the first user via the first device during the video call. An avatar may refer to a graphical representation of a user, a character of the user, or a person of the user. In one aspect, the object library 416 may be centralized (e.g., a data server). In another aspect, the object library 416 may be distributed (e.g., multiple data centers along with a content distribution network).

The object library 416 may store objects 418. In an example, the objects 418 may be used for the XR application. The objects 418 may include images 420, 3D meshes 422, and 3D assets 424. A 3D mesh may refer to a collection of vertices, edges, and faces that define a shape of a polyhedral object.

The 3D assets 424 may include normal maps 426, Albedo maps 428, and specular maps 430. A normal map may refer to a red green blue (RGB) image in which RGB components of the image correspond to an X coordinate, a Y coordinate, and a Z coordinate, respectively, of a surface normal. An Albedo map may refer to a base color input that defines a diffuse color or a reflectively or a surface. An Albedo map may be associated with a pure color of an object. A specular map may refer to a black and white image that determines a shininess or a reflectively of a rendered object in three dimensions.

The objects 418 may also include avatar network weights 432 and digital twin network weights 434. Network weights may be a set of values for a set of parameters of a computing graph (e.g., a neural network). The avatar network weights 432 and/or the digital twin network weights 434 may be collectively referred to as network weights. The avatar network weights 432 may be a set of values that facilitate display, animation, and/or other interactivity elements of an avatar. The digital twin network weights 434 may be a set of values that facilitate display, animation, and/or other interactivity elements of a digital twin. A digital twin may refer to a digital model of an intended or actual real-world physical product, system, or process that serves as an effectively indistinguishable counterpart of the intended or actual real-world physical product, system, or process for purposes such as simulation, integration, testing, monitoring, and/or maintenance. In the case of an avatar call, the 3D meshes 422, the 3D assets 424 (including the normal maps 426, the Albedo maps 428, and the specular maps 430), and the avatar network weights 432 may be collectively referred to as enroll data.

The object library 416 may support and/or store reduced object forms 438, where the reduced object forms 438 may be a simplified version of the objects 418. In an example, the reduced object forms 438 may occupy less data storage than data storage occupied by the objects 418. The reduced object forms 438 may include low resolution images 440 (e.g., width×height) of the images 420. For instance, the images 420 may include a first instance of an image at a first resolution, and the low resolution images 440 may include a second instance of the image at a second resolution, where the second resolution is lower than the first resolution.

The reduced object forms 438 may include a numbers of vertices 442 of the 3D meshes 422. The reduced object forms 438 may include hash function outputs 444. The hash function outputs 444 may be hashes generated as part of a hash function executed with respect to the objects 418. The reduced object forms 438 may also include indices 446 of the objects 418. The reduced object forms 438 may include file names 448 of the objects 418. The reduced object forms 438 may include identifiers (IDs) 450 of the objects 418, where the IDs 450 may be different from the indices 446 and the file names 448. In an example, the IDs 450 may include strings. A string may refer to a sequence of characters.

The first device 404 may transmit a query 452 to the object library 416. The query 452 may indicate an object in the objects 418. The object library 416 may receive the query 452. The object library 416 may determine supported reduced form(s) 454 of the object based on the query 452. In an example, the supported reduced form(s) 454 of the object may include one or more of the reduced object forms 438. The object library 416 may transmit an indication of the supported reduced form(s) 454 of the object to the first device 404. The first device 404 may receive the indication of the supported reduced form(s) 454 of the object. The first device 404 may select a reduced form in the supported reduced form(s) 454 of the object. The first device 404 may transmit an indication of a selected reduced form 456 of the object to the object library 416. In an example, the indication of the selected reduced form 456 of the object may be a reduced object form in the reduced object forms 438, such as a low resolution image, an indication of a number of vertices of the object, etc. The object library 416 may receive the indication of the selected reduced form 456 of the object. The object library 416 may attempt to retrieve the object based on the indication of the selected reduced form 456. The object library 416 may transmit an indication of an outcome 458 of the retrieval to the first device 404, where the indication of the outcome 458 may indicate whether the object library 416 successfully or unsuccessfully retrieved the object according to the selected reduced form 456. Aspects pertaining to successful and unsuccessful retrieval of the object are described in greater detail below.

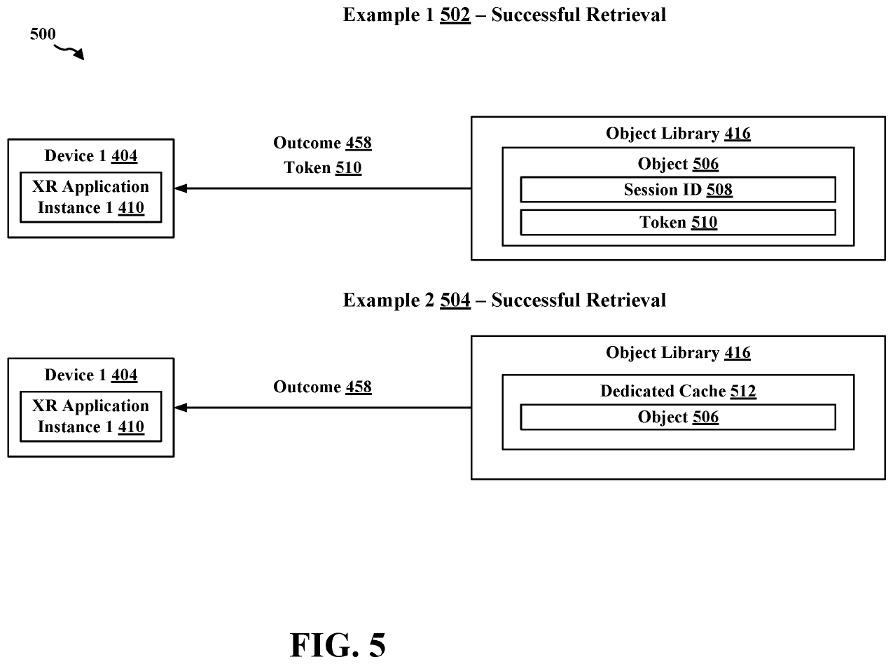

FIG. 5 is a diagram 500 illustrating a first example 502 and a second example 504 of a successful retrieval of a requested object in a reduced form in accordance with one or more techniques of this disclosure. As described above, the object library 416 may transmit the indication of the outcome 458 to the first device 404, where the indication of the outcome 458 may indicate whether the object library 416 successfully or unsuccessfully retrieved the object according to the selected reduced form 456. In the first example 502, the object library 416 may successfully retrieve an object 506 based on the indication of the selected reduced form 456, and hence the indication of the outcome 458 may indicate that the object library 416 successfully retrieved the object 506. In order to facilitate fast retrieval of the object 506 in the future, the object library 416 may label the object 506 in the object library 416 with a session ID 508 corresponding to the second session 414. Additionally, or alternatively, the object library 416 may create a token 510 associated with the object 506, where the token 510 may facilitate fast retrieval of the object 506 in the future. In the event that the object library 416 creates the token 510, the object library 416 may transmit the token 510 (or an indication thereof) to the first device 404 along with the indication of the outcome 458.

In the second example 504, the object library 416 may successfully retrieve an object 506 based on the indication of the selected reduced form 456, and hence the indication of the outcome 458 may indicate that the object library 416 successfully retrieved the object 506. The object library 416 may store object 506 in a dedicated cache 512.

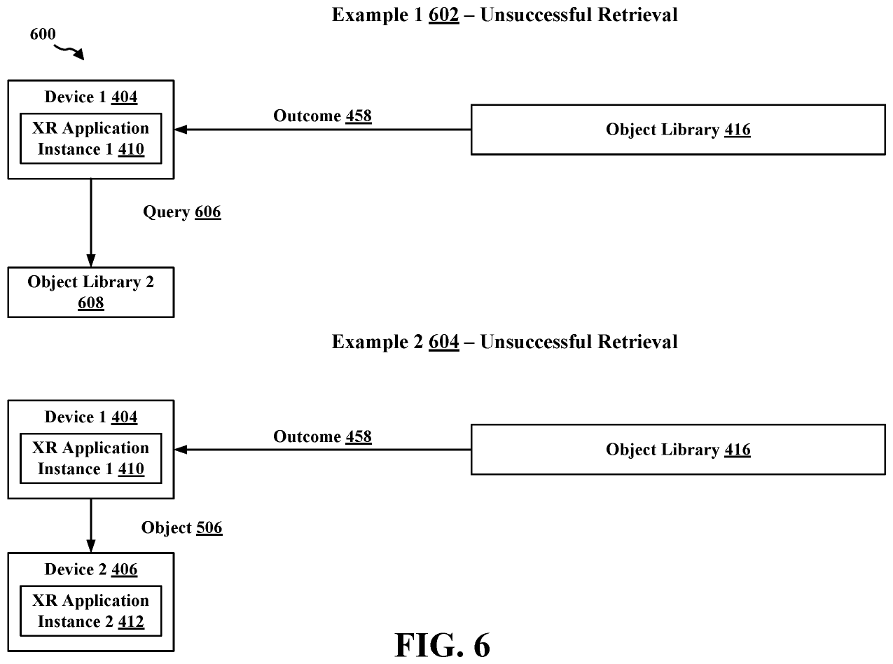

FIG. 6 is a diagram 600 illustrating a first example 602 and a second example 604 of an unsuccessful retrieval of a requested object in a reduced form in accordance with one or more techniques of this disclosure. As described above, the object library 416 may transmit the indication of the outcome 458 to the first device 404, where the indication of the outcome 458 may indicate whether the object library 416 successfully or unsuccessfully retrieved the object according to the selected reduced form 456.

In the first example 602, the object library 416 may fail in retrieving the object 506 based on the indication of the selected reduced form 456, and hence the indication of the outcome 458 may indicate that the object library 416 unsuccessfully retrieved the object 506. Based on the indication of the outcome 458, the first device 404 may transmit a query 606 for the object 506 to a second object library 608 (i.e., a different object library).

In the second example 604, the object library 416 may fail in retrieving the object 506 based on the indication of the selected reduced form 456, and hence the indication of the outcome 458 may indicate that the object library 416 unsuccessfully retrieved the object 506. Based on the indication of the outcome 458, the first device 404 may transmit the object 506 to the second device 406. For instance, the first device 404 may transmit the object 506 to the second device 406 directly without going through the object library 416.

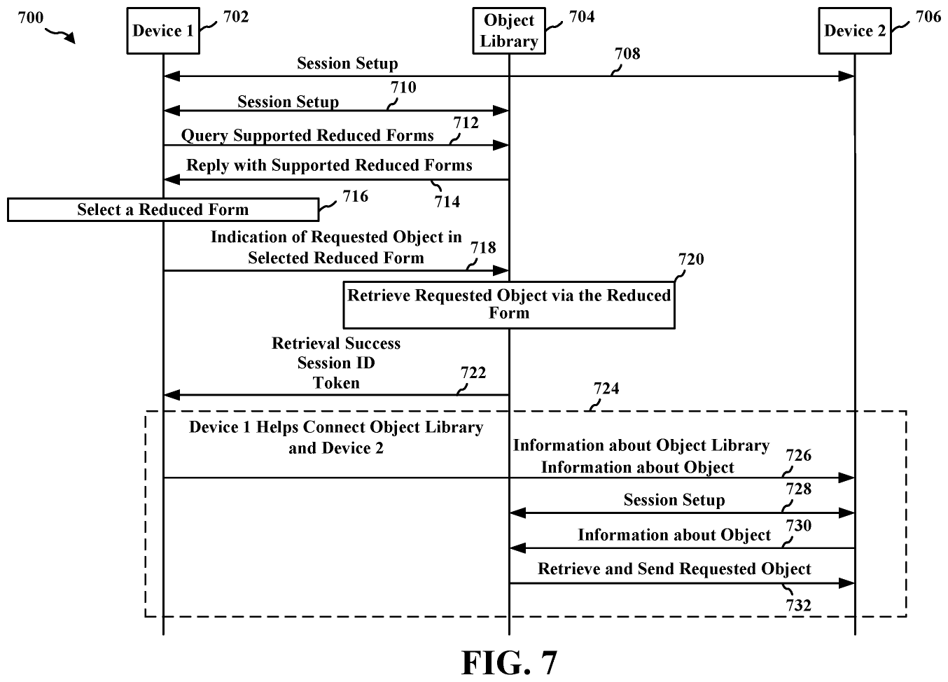

FIG. 7 is a call flow diagram 700 illustrating example communications between a first device 702, an object library 704, and a second device 706 in accordance with one or more techniques of this disclosure. In an example, the first device 702 may be or include the first device 404, the object library 704 may be or include the object library 416, and the second device 706 may be or include the second device 406.

At 708, the first device 702 and the second device 706 may establish a first session with one another (i.e., setup a session). At 710, the first device 702 and the object library 704 may establish a second session with one another (i.e., setup a session).

At 712, the first device 702 may query the object library 704 for supported reduced forms of an object. At 714, the object library 704 may reply to the query with supported reduced forms of the object. At 716, the first device 702 may select a reduced form. At 718, the first device 702 may transmit an indication of the requested object in the selected reduced form. At 720, the object library 704 may retrieve the requested object via the reduced form. At 722, the object library 704 may transmit an indication of retrieval success to the first device 702. In one aspect, at 722, the object library 704 may also transmit an indication of a session ID along with the indication of the retrieval success. In another aspect, at 722, the object library 704 may also transmit a token (or an indication thereof) along with the indication of the retrieval success.

At 724, the first device 702 may help to connect the object library 704 and the second device 706. For instance, at 726, the first device 702 may transmit information about the object library 704 and information about the object to the second device 706. The information about the object library 704 may include an Internet Protocol (IP) address of the object library 704. The information about the object may include a reduced form of the object (or an indication thereof), the session ID (or an indication thereof) between the first device 702 and the object library 704, and/or the token (or an indication thereof).

At 728, the object library 704 and the second device 706 may establish a second session with one another (i.e., setup a session) based on the information about the object library transmitted at 726. For instance, the second device 706 may initiate and establish the second session with the object library 704 based on the information about the object library. At 730, the second device 706 may transmit the information about the object (or an indication thereof) to the object library 704. At 732, the object library 704 may retrieve the object based on the information about the object (e.g., using the reduced form of the object) and the object library 704 may transmit (i.e., send) the requested object to the second device 706. The first device 702 and the second device 706 may then start an XR application (e.g., using the requested object). For example, the first device 702 and the second device 706 may engage in an avatar call using the requested object, engage in a video game, etc.

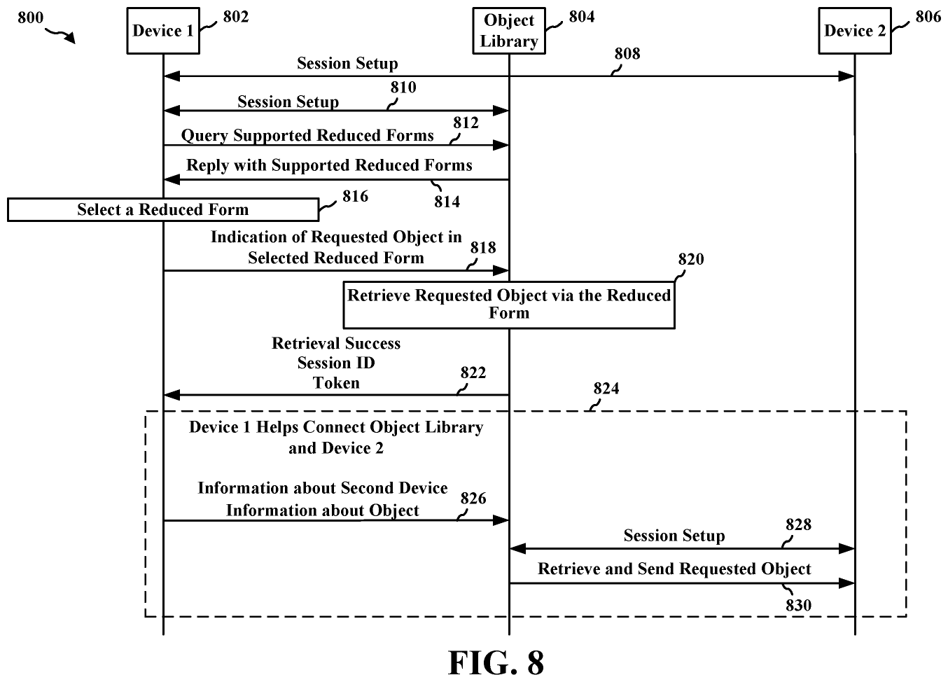

FIG. 8 is a call flow diagram 800 illustrating example communications between a first device, an object library, and a second device in accordance with one or more techniques of this disclosure. In an example, the first device 802 may be or include the first device 404, the object library 804 may be or include the object library 416, and the second device 806 may be or include the second device 406.

At 808, the first device 802 and the second device 806 may establish a first session with one another (i.e., setup a session). At 810, the first device 802 and the object library 804 may establish a second session with one another (i.e., setup a session).

At 812, the first device 802 may query the object library 804 for supported reduced forms of an object. At 814, the object library 804 may reply to the query with supported reduced forms of the object. At 816, the first device 802 may select a reduced form. At 818, the first device 802 may transmit an indication of the requested object in the selected reduced form. At 820, the object library 804 may retrieve the requested object via the reduced form. At 822, the object library 804 may transmit an indication of retrieval success to the first device 802. In one aspect, at 822, the object library 804 may also transmit an indication of a session ID along with the indication of the retrieval success. In another aspect, at 822, the object library 804 may also transmit a token (or an indication thereof) along with the indication of the retrieval success.

At 824, the first device 802 may help to connect the object library 804 and the second device 806. For instance, at 826, the first device 802 may transmit information about the second device 806 to the object library 804. The information about the second device 806 may include an Internet Protocol (IP) address of the second device 806. Additionally, in one aspect, at 826, the first device 802 may also transmit information about the object to the object library 804. The information about the object may include a reduced form of the object (or an indication thereof), the session ID (or an indication thereof) between the first device 802 and the object library 804, and/or the token (or an indication thereof).

At 828, the object library 804 and the second device 806 may establish a second session with one another (i.e., setup a session) based on the information about the second device 806 transmitted at 826. For instance, the object library 804 may initiate and establish the second session with the second device 806 based on the information about the second device. At 830, the object library 804 may retrieve the object and the object library 804 may transmit (i.e., send) the requested object to the second device 806. In one aspect, the object library 804 may retrieve the object based on the information about the object (e.g., using the reduced form of the object) transmitted at 826. In another aspect, the object library 804 may retrieve the requested object based on the indication transmitted at 818. The first device 802 and the second device 806 may then start an XR application (e.g., using the requested object). For example, the first device 802 and the second device 806 may engage in an avatar call using the requested object, engage in a video game, etc.

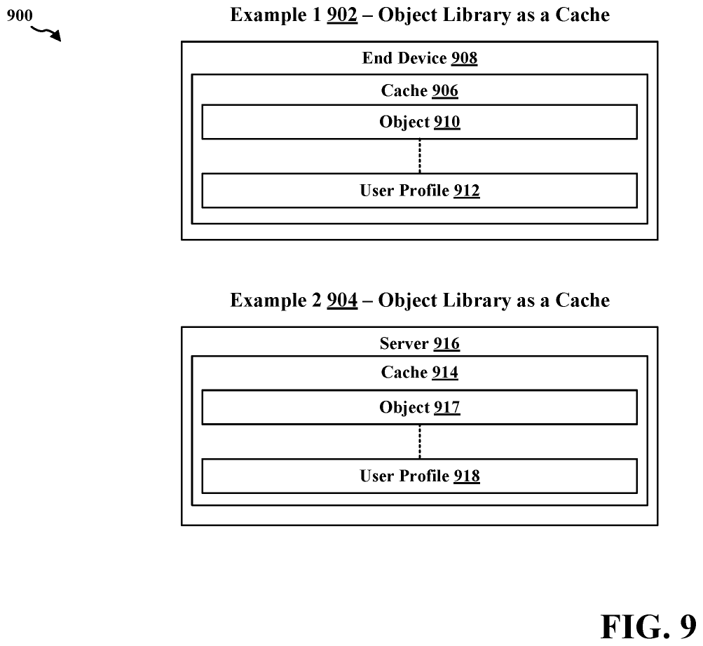

FIG. 9 is a diagram 900 illustrating a first example 902 and a second example 904 of an object library as a cache in accordance with one or more techniques of this disclosure. As described herein, an object library may be or include a cache.

In the first example 902, an object library (e.g., the object library 416, the object library 704, the object library 804) may be a cache 906 on an end device 908. For instance, the cache 906 may store the objects 418, such as the enroll data 436, which, as noted above, may include a 3D mesh, 3D assets (e.g., normal maps, Albedo maps, specular maps), and network weights for avatar reconstruction. In an example, the end device 908 may be the device 104, the first device 404, the second device 406, the first device 702, the second device 706, the first device 802, or the second device 806.

In the first example 902, the cache 906 may store an object 910, where the object 910 may be included in the objects 418. In an example, the object 910 may include enroll data of an avatar of a user that was sent to the end device (e.g., the device 104, the first device 404, the first device 702, the first device 802) in a previous session. A user profile 912 of a user may be stored and/or associated with the object 910 in the cache 906. In an example, the user profile 912 may be for a first user of a first device or a second user of a second device.

In the second example 904, an object library (e.g., the object library 416, the object library 704, the object library 804) may be a cache 914 on a server 916. In an example, the server 916 may be a cloud server and hence the cache 914 may be a cloud cache. The server 916 may be a server in a communication network. The cache 914 may store an object 917, where the object 917 may be included in the objects 418. A user profile 918 of a user may be stored and/or associated with the object 917 in the cache 914. In an example, the object 917 may be associated with the user. In example, if the user changes devices (e.g., from a first device to a second device), the object 917 may be fetched from the cache 914 using the user profile 918.

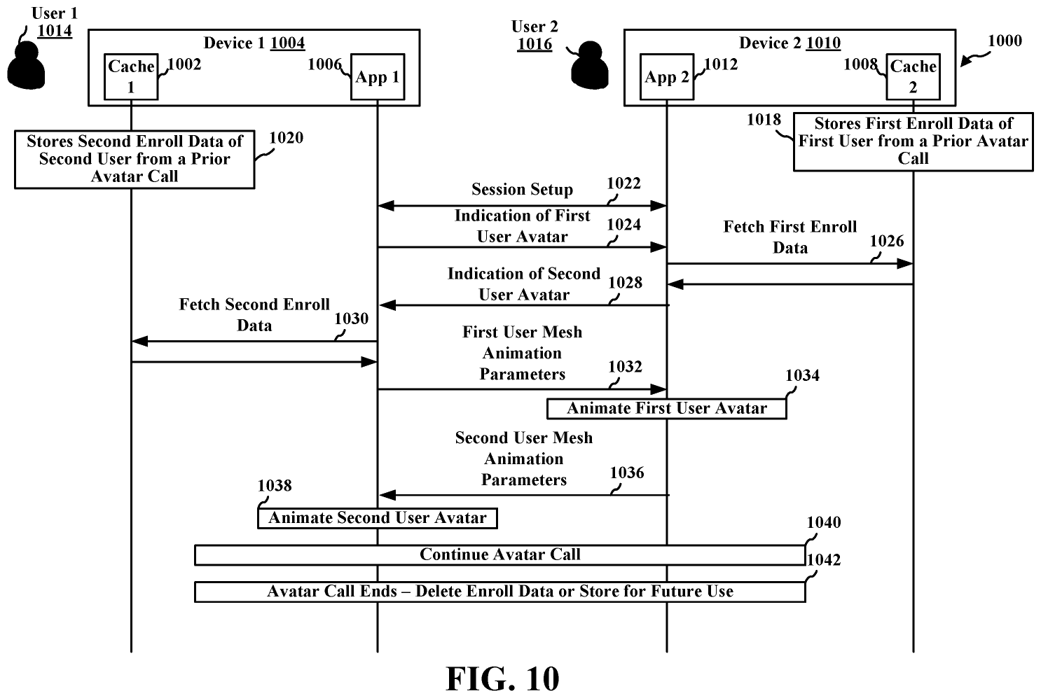

FIG. 10 is a call flow diagram 1000 illustrating example communications between a first cache 1002 of a first device 1004, a first application 1006 (abbreviated as “App 1” in FIG. 10) of the first device, a second cache 1008 of a second device 1010, and a second application 1012 (abbreviated as “App 2” in FIG. 10) of the second device 1010 in accordance with one or more techniques of this disclosure. In an example, the first device 1004 may be associated with and/or operated by a first user 1014 and the second device 1010 may be associated with and/or operated by a second user 1016. In an example, the first device 1004 may be the device 104, the first device 404, the first device 702, or the first device 802. In an example, the second device 1010 may be the device 104, the second device 406, the second device 706, or the second device 806. In an example, the first application 1006 may be the first XR application instance 410 and the second application 1012 may be the second XR application instance 412. In an example, the first device 1004 may be a first end device and the second device 1010 may be a second end device.

At 1018, the second cache 1008 may store first enroll data (e.g., the enroll data 436) of the first user 1014 from a prior avatar call. At 1020, the first cache 1002 may store second enroll data of the second user 1016 from the prior avatar call. At 1022, the first application 1006 and the second application 1012 may establish a session with one another. At 1024, the first application 1006 may transmit an indication of a first user avatar of the first user 1014 (e.g., from amongst first multiple different avatars) that the first user 1014 wishes to use during an avatar call. At 1026, based on the indication transmitted at 1024, the second application 1012 may fetch the first enroll data from the second cache 1008. At 1028, the second application 1012 may transmit an indication of a second user avatar of the second user 1016 (e.g., from amongst second multiple different avatars) that the second user 1016 wishes to use during the avatar call. At 1030, based on the indication transmitted at 1028, the first application 1006 may fetch the second enroll data from the first cache 1002. At 1032, the first application 1006 may transmit (i.e., send) first user mesh animation parameters to the second application 1012. Mesh animation parameters may refer to data used to animate a mesh. The first user mesh animation parameters may include indication(s) of a facial expression, a pose, etc., of the first user 1014. At 1034, the second application 1012 may animate a first user avatar of the first user 1014 based on the first user mesh animation parameters and the first enroll data. At 1036, the second application 1012 may transmit (i.e., send) second user mesh animation parameters to the first application 1006. The second user mesh animation parameters may include indication(s) of a facial expression, a pose, etc. of the second user 1016. At 1038, the first application 1006 may animate a second user avatar of the second user 1016 based on the second user mesh animation parameters and the second enroll data. At 1040, the first application 1006 and the second application 1012 may continue with the avatar call. At 1042, the avatar call may end. The first application 1006 may delete the second enroll data or the first application 1006 may store the second enroll data in the first cache 1002. Similarly, the second application 1012 may delete the first enroll data or the second application 1012 may store the first enroll data in the second cache 1008.

In one aspect, the first device 1004 may directly send the first enroll data of the first user 1014 to the second device 1010 and the second device 1010 may directly send the second enroll data of the second user 1016 to the first device 1004. Although the description of FIG. 10 is focused on avatar calls, the concepts discussed above with respect to FIG. 10 may be applicable to other types of multimedia communication applications in which an object is fetched from a cache or in which the object is directly sent from a first end device to a second end device.

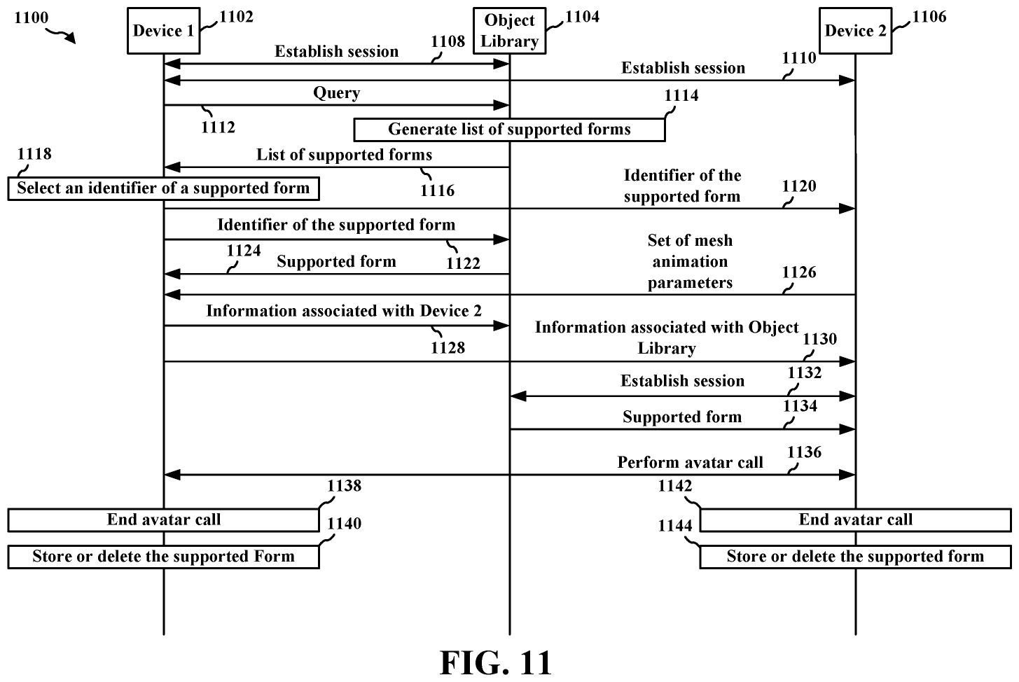

FIG. 11 is a call flow diagram 1100 illustrating example communications between a first device 1102, an object library 1104, and a second device 1106 in accordance with one or more techniques of this disclosure. In an example, the first device 1102, the object library 1104, or the second device 1106 may be the device 104. In an example, the first device 1102 may be or include the first device 404, the first device 702, the first device 802, the end device 908, or the first device 1004. In an example, the object library 1104 may be or include the object library 416, the object library 704, the object library 804, the end device 908, the server 916, the first device 1004, or the second device 1010. In an example, the second device 1106 may be or include the second device 406, the second device 706, the second device 806, or the second device 1010. At 1112, the first device 1102 may transmit, to an object library (e.g., the object library 1104), a query for supported forms of enroll data of an avatar of a second user, where the first device may be associated with a first user and a second device (e.g., the second device 1106) may be associated with the second user. At 1116, the first device 1102 may receive, from the object library and based on the query, a list of the supported forms of the enroll data. At 1120, the first device 1102 may transmit, to the second device, an identifier of a supported form in the list of the supported forms. At 1136, the first device 1102 may perform an avatar call with the second device based on the transmitted identifier of the supported form.

At 1118, the first device 1102 may select the identifier of the supported form after the reception of the list of the supported forms, where transmitting the identifier of the supported form at 1120 may include transmitting the selected identifier of the supported form. At 1122, the first device 1102 may transmit, to the object library, the selected identifier of the supported form. At 1124, the first device 1102 may receive, from the object library, the supported form, where performing the avatar call at 1136 may include performing the avatar call based on the received supported form.

At 1138, the first device 1102 may end the avatar call with the second device. At 1140, the first device 1102 may store the supported form or delete the supported form.

At 1108, the first device 1102 may establish a first session with the object library, where transmitting the query at 1112 may include transmitting the query during the first session, and where receiving the list of the supported forms at 1116 may include receiving the list of the supported forms during the first session. At 1110, the first device 1102 may establish a second session with the second device, where transmitting the identifier of the supported form at 1120 may include transmitting the identifier of the supported form during the second session, and where performing the avatar call with the second device at 1136 may include performing the avatar call with the second device during the second session.

At 1126, the first device 1102 may receive, from the second device and based on the identifier of the supported form, a set of mesh animation parameters for the avatar of the second user, where performing the avatar call at 1136 may include animating the avatar of the second user based on the set of mesh animation parameters. At 1128, the first device 1102 may transmit, to the object library, information associated with the second device, where performing the avatar call with the second device at 1136 may be further based on the transmitted information associated with the second device.

At 1112, the object library 1104 may receive, from a first device (e.g., the first device 1102) of a first user, a query for supported forms of enroll data of an avatar of a second user. At 1116, the object library 1104 may transmit, to the first device and based on the query, a list of the supported forms of the enroll data. At 1122, the object library 1104 may receive, from the first device, an identifier of a supported form in the list of the supported forms. At 1124, the object library 1104 may transmit, to the first device, the supported form, where the supported form is associated with an avatar call between the first device and a second device (e.g., the second device 1106) of the second user.

At 1114, the object library 1104 may generate, based on the query, the list of the supported forms of the enroll data, where transmitting the list of the supported forms of the enroll data at 1116 may include transmitting the generated list of the supported forms of the enroll data. At 1108, the object library 1104 may establish a first session between the object library and the first device, where receiving the query at 1112 may include receiving the query during the first session, and where transmitting the list of the supported forms at 1116 may include transmitting the list of the supported forms during the first session. At 1128, the object library 1104 may receive, from the first device, information associated with the second device. At 1132, the object library 1104 may establish a second session between the object library and the second device based on the information associated with the second device. At 1134, the object library 1104 may transmit, to the second device, the supported form.

At 1120, the second device 1106 may receive an identifier of a supported form in a list of supported forms of enroll data of an avatar of a second user, where the list of supported forms may be associated with an object library (e.g., the object library 1104), where the second device may be associated with the second user. At 1136, the second device 1106 may perform an avatar call with a first device (e.g., the first device 1102) of a first user based on the received identifier of the supported form.

At 1134, the second device 1106 may receive, from the object library, the supported form, where performing the avatar call with the first device at 1136 may include performing the avatar call further based on the supported form. At 1142, the second device 1106 may end the avatar call with the first device. At 1144, the second device 1106 may store the supported form or delete the supported form. At 1110, the second device 1106 may establish a first session with the first device. At 1132, the second device 1106 may establish a second session with the object library based on the established first session, where performing the avatar call with the first device at 1136 may include performing the avatar call during the second session. At 1130, the second device 1106 may receive, from the first device, information associated with the object library, where establishing the second session at 1132 may include establishing the second session further based on the received information.

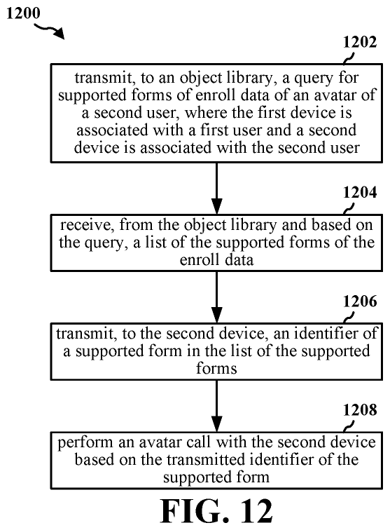

FIG. 12 is a flowchart 1200 of an example method of graphics processing in accordance with one or more techniques of this disclosure. The method may be performed by an apparatus, such as an apparatus for graphics processing, a GPU, a CPU, the device 104, the first device 404, the first device 702, the first device 802, the end device 908, the first device 1004, the first device 1102, a wireless communication device, and the like, as used in connection with the aspects of FIGS. 1-11. In an example, the method may be performed by the reduced form provider 197.

At 1202, the apparatus (e.g., a first device) transmits, to an object library, a query for supported forms of enroll data of an avatar of a second user, where the first device is associated with a first user and a second device is associated with the second user. For example, FIG. 11 at 1112 shows that the first device 1102 may transmit, to an object library, a query for supported forms of enroll data of an avatar of a second user, where the first device is associated with a first user and a second device is associated with the second user. In an example, the object library may be or include the object library 416, the object library 704, the object library 804, the end device 908, the server 916. In an example, the query may be or include the query 452. In an example, the supported forms of the enroll data may be or include the reduced object forms 438. In an example, the enroll data may be or include the enroll data 436. In an example, the first user may be the first user 1014 and the second user may be the second user 1016. In an example, the second device may be or include the second device 406, the second device 706, the second device 806, the second device 1010, or the second device 1106. In an example, 1202 may be performed by the reduced form provider 197.

At 1204, the apparatus (e.g., a first device) receives, from the object library and based on the query, a list of the supported forms of the enroll data. For example, FIG. 11 at 1116 shows that the first device 1102 may receive, from the object library and based on the query, a list of the supported forms of the enroll data. In an example, the list may be or may be associated with the supported reduced form(s) 454. In an example, 1204 may be performed by the reduced form provider 197.

At 1206, the apparatus (e.g., a first device) transmits, to the second device, an identifier of a supported form in the list of the supported forms. For example, FIG. 11 at 1120 shows that the first device 1102 may transmit, to the second device, an identifier of a supported form in the list of the supported forms. In an example, the identifier of the supported form may be or may be associated with the selected reduced form 456. In an example, 1206 may be performed by the reduced form provider 197.

At 1208, the apparatus (e.g., a first device) performs an avatar call with the second device based on the transmitted identifier of the supported form. For example, FIG. 11 at 1136 shows that the first device 1102 may perform an avatar call with the second device based on the transmitted identifier of the supported form. In an example, 1208 may be performed by the reduced form provider 197.

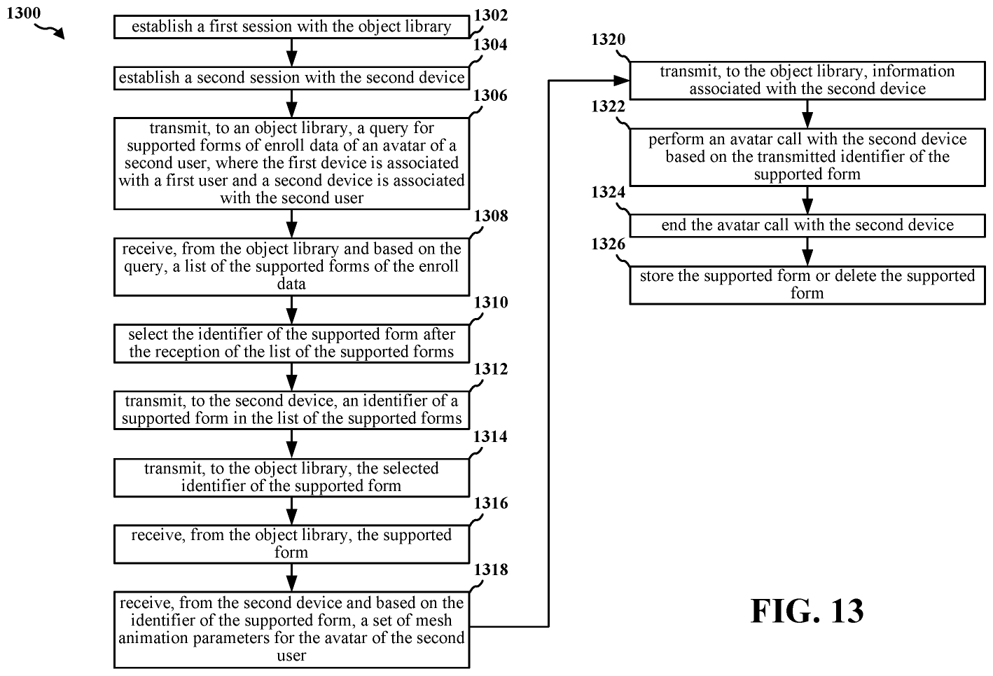

FIG. 13 is a flowchart 1300 of an example method of graphics processing in accordance with one or more techniques of this disclosure. The method may be performed by an apparatus, such as an apparatus for graphics processing, a GPU, a CPU, the device 104, the first device 404, the first device 702, the first device 802, the end device 908, the first device 1004, the first device 1102, a wireless communication device, and the like, as used in connection with the aspects of FIGS. 1-11. In an example, the method (including the various aspects detailed below) may be performed by the reduced form provider 197.

At 1306, the apparatus (e.g., a first device) transmits, to an object library, a query for supported forms of enroll data of an avatar of a second user, where the first device is associated with a first user and a second device is associated with the second user. For example, FIG. 11 at 1112 shows that the first device 1102 may transmit, to an object library, a query for supported forms of enroll data of an avatar of a second user, where the first device is associated with a first user and a second device is associated with the second user. In an example, the object library may be or include the object library 416, the object library 704, the object library 804, the end device 908, the server 916. In an example, the query may be or include the query 452. In an example, the supported forms of the enroll data may be or include the reduced object forms 438. In an example, the enroll data may be or include the enroll data 436. In an example, the first user may be the first user 1014 and the second user may be the second user 1016. In an example, the second device may be or include the second device 406, the second device 706, the second device 806, the second device 1010, or the second device 1106. In an example, 1306 may be performed by the reduced form provider 197.

At 1308, the apparatus (e.g., a first device) receives, from the object library and based on the query, a list of the supported forms of the enroll data. For example, FIG. 11 at 1116 shows that the first device 1102 may receive, from the object library and based on the query, a list of the supported forms of the enroll data. In an example, the list may be or may be associated with the supported reduced form(s) 454. In an example, 1308 may be performed by the reduced form provider 197.

At 1312, the apparatus (e.g., a first device) transmits, to the second device, an identifier of a supported form in the list of the supported forms. For example, FIG. 11 at 1120 shows that the first device 1102 may transmit, to the second device, an identifier of a supported form in the list of the supported forms. In an example, the identifier of the supported form may be or may be associated with the selected reduced form 456. In an example, 1312 may be performed by the reduced form provider 197.

At 1322, the apparatus (e.g., a first device) performs an avatar call with the second device based on the transmitted identifier of the supported form. For example, FIG. 11 at 1136 shows that the first device 1102 may perform an avatar call with the second device based on the transmitted identifier of the supported form. In an example, 1322 may be performed by the reduced form provider 197.

In one aspect, the list of the supported forms of the enroll data may include at least one of a three-dimensional (3D) mesh, a normal map, an Albedo map, a specular map, or network weights. For example, the aforementioned aspect may correspond to the 3D meshes 422, the normal maps 426, the Albedo maps 428, the specular maps 430, the avatar network weights 432, or the digital twin network weights 434.

In one aspect, at 1310, the apparatus (e.g., a first device) may select the identifier of the supported form after the reception of the list of the supported forms, where transmitting the identifier of the supported form may include transmitting the selected identifier of the supported form. For example, FIG. 11 at 1118 shows that the first device 1102 may select the identifier of the supported form after the reception of the list of the supported forms, where transmitting the identifier of the supported form at 1120 may include transmitting the selected identifier of the supported form. In an example, 1310 may be performed by the reduced form provider 197.

In one aspect, at 1314, the apparatus (e.g., a first device) may transmit, to the object library, the selected identifier of the supported form. For example, FIG. 11 at 1122 shows that the first device 1102 may transmit, to the object library, the selected identifier of the supported form. In an example, 1314 may be performed by the reduced form provider 197.

In one aspect, at 1316, the apparatus (e.g., a first device) may receive, from the object library, the supported form, where performing the avatar call may include performing the avatar call based on the received supported form. For example, FIG. 11 at 1124 shows that the first device 1102 may receive, from the object library, the supported form, where performing the avatar call at 1136 may include performing the avatar call based on the received supported form. In an example, 1316 may be performed by the reduced form provider 197.

In one aspect, at 1324, the apparatus (e.g., a first device) may end the avatar call with the second device. For example, FIG. 11 at 1138 shows that the first device 1102 may end the avatar call with the second device. In an example, the aforementioned aspect may correspond to 1042 in FIG. 10. In an example, 1324 may be performed by the reduced form provider 197.

In one aspect, at 1326, the apparatus (e.g., a first device) may store the supported form or delete the supported form. For example, FIG. 11 at 1140 shows that the first device 1102 may store the supported form or delete the supported form. In an example, the aforementioned aspect may correspond to 1042 in FIG. 10. In an example, 1326 may be performed by the reduced form provider 197.

In one aspect, the object library may include a first cache at the first device or second cache at a server. For example, the first cache may be the cache 906 and the first device may be the end device 908. In another example, the second cache may be the cache 914 and the server may be the server 916.

In one aspect, performing the avatar call with the second device may include displaying the avatar of the second user on a display of the first device. For example, performing the avatar call with the second device at 1136 may include displaying the avatar of the second user on a display of the first device.

In one aspect, at 1302, the apparatus (e.g., a first device) may establish a first session with the object library, where transmitting the query may include transmitting the query during the first session, and where receiving the list of the supported forms may include receiving the list of the supported forms during the first session. For example, FIG. 11 at 1108 shows that the first device 1102 may establish a first session with the object library, where transmitting the query at 1112 may include transmitting the query during the first session, and where receiving the list of the supported forms at 1116 may include receiving the list of the supported forms during the first session. In an example, the first session may be or include the second session 414. In an example, 1302 may be performed by the reduced form provider 197.

In one aspect, at 1304, the apparatus (e.g., a first device) may establish a second session with the second device, where transmitting the identifier of the supported form may include transmitting the identifier of the supported form during the second session, and where performing the avatar call with the second device may include performing the avatar call with the second device during the second session. For example, FIG. 11 at 1110 shows that the first device 1102 may establish a second session with the second device, where transmitting the identifier of the supported form at 1120 may include transmitting the identifier of the supported form during the second session, and where performing the avatar call with the second device at 1136 may include performing the avatar call with the second device during the second session. In an example, the second session may be the first session 408. In an example, 1304 may be performed by the reduced form provider 197.

In one aspect, at 1318, the apparatus (e.g., a first device) may receive, from the second device and based on the identifier of the supported form, a set of mesh animation parameters for the avatar of the second user, where performing the avatar call may include animating the avatar of the second user based on the set of mesh animation parameters. For example, FIG. 11 at 1126 shows that the first device 1102 may receive, from the second device and based on the identifier of the supported form, a set of mesh animation parameters for the avatar of the second user, where performing the avatar call at 1136 may include animating the avatar of the second user based on the set of mesh animation parameters. In an example, the aforementioned aspect may correspond to 1036 in FIG. 10. In an example, 1318 may be performed by the reduced form provider 197.

In one aspect, at 1320, the apparatus (e.g., a first device) may transmit, to the object library, information associated with the second device, where performing the avatar call with the second device may be further based on the transmitted information associated with the second device. For example, FIG. 11 at 1128 shows that the first device 1102 may transmit, to the object library, information associated with the second device, where performing the avatar call with the second device at 1136 may be further based on the transmitted information associated with the second device. In an example, the aforementioned aspect may correspond to 826 in FIG. 8. In an example, 1320 may be performed by the reduced form provider 197.

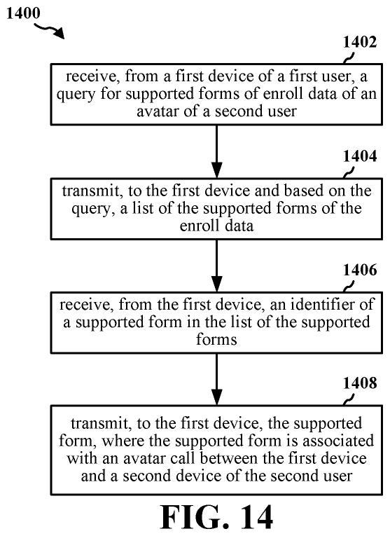

FIG. 14 is a flowchart 1400 of an example method of graphics processing in accordance with one or more techniques of this disclosure. The method may be performed by an apparatus, such as an apparatus for graphics processing, a GPU, a CPU, the device 104, the object library 416, the object library 704, the object library 804, the end device 908, the server 916, the first device 1004, the second device 1010, the object library 1104, a wireless communication device, and the like, as used in connection with the aspects of FIGS. 1-11. In an example, the method may be performed by the reduced form provider 198.

At 1402, the apparatus (e.g., an object library) receives, from a first device of a first user, a query for supported forms of enroll data of an avatar of a second user. For example, FIG. 11 at 1112 shows that the object library 1104 may receive, from a first device of a first user, a query for supported forms of enroll data of an avatar of a second user. In an example, the first device may be or include the first device 404, the first device 702, the first device 802, the first device 1004, or the first device 1102. In an example, the query may be or include the query 452. In an example, the supported forms of the enroll data may be or include the reduced object forms 438. In an example, the enroll data may be or include the enroll data 436. In an example, the first user may be the first user 1014 and the second user may be the second user 1016. In an example, 1402 may be performed by the reduced form provider 198.

At 1404, the apparatus (e.g., an object library) transmits, to the first device and based on the query, a list of the supported forms of the enroll data. For example, FIG. 11 at 1116 shows that the object library 1104 may transmit, to the first device and based on the query, a list of the supported forms of the enroll data. In an example, the list may be or may be associated with the supported reduced form(s) 454. In an example, 1404 may be performed by the reduced form provider 198.

At 1406, the apparatus (e.g., an object library) receives, from the first device, an identifier of a supported form in the list of the supported forms. For example, FIG. 11 at 1122 shows that the object library 1104 may receive, from the first device, an identifier of a supported form in the list of the supported forms. In an example, the identifier of the supported form may be or may be associated with the selected reduced form 456. In an example, 1406 may be performed by the reduced form provider 198.

At 1408, the apparatus (e.g., an object library) transmits, to the first device, the supported form, where the supported form is associated with an avatar call between the first device and a second device of the second user. For example, FIG. 11 at 1124 shows that the object library 1104 may transmit, to the first device, the supported form, where the supported form is associated with an avatar call between the first device and a second device of the second user. In an example, the second device may be or include the second device 406, the second device 706, the second device 806, the second device 1010, or the second device 1106. In an example, 1408 may be performed by the reduced form provider 198.

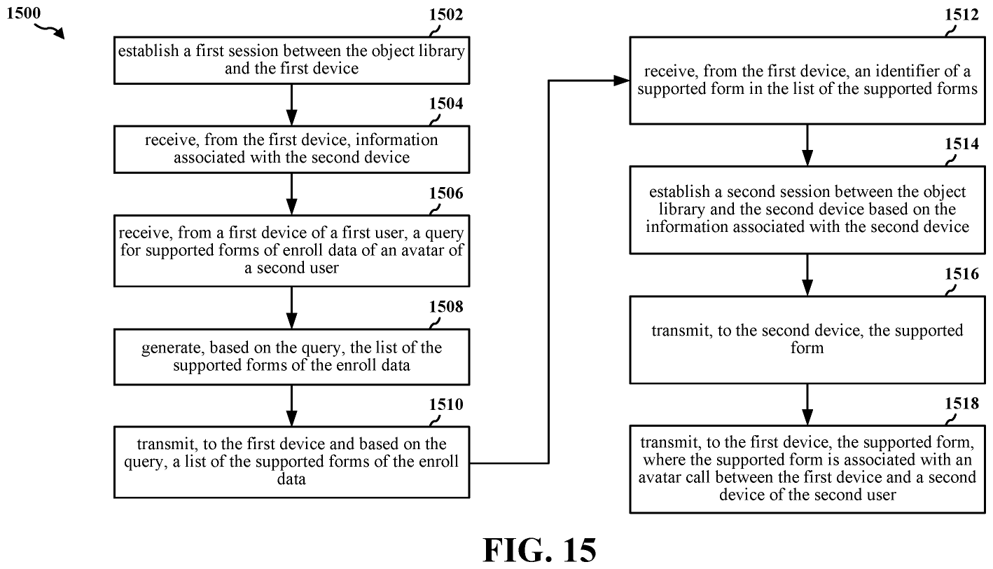

FIG. 15 is a flowchart 1500 of an example method of graphics processing in accordance with one or more techniques of this disclosure. The method may be performed by an apparatus, such as an apparatus for graphics processing, a GPU, a CPU, the device 104, the object library 416, the object library 704, the object library 804, the end device 908, the server 916, the first device 1004, the second device 1010, the object library 1104, a wireless communication device, and the like, as used in connection with the aspects of FIGS. 1-11. In an example, the method (including the various aspects detailed below) may be performed by the reduced form provider 198.

At 1506, the apparatus (e.g., an object library) receives, from a first device of a first user, a query for supported forms of enroll data of an avatar of a second user. For example, FIG. 11 at 1112 shows that the object library 1104 may receive, from a first device of a first user, a query for supported forms of enroll data of an avatar of a second user. In an example, the first device may be or include the first device 404, the first device 702, the first device 802, the first device 1004, or the first device 1102. In an example, the query may be or include the query 452. In an example, the supported forms of the enroll data may be or include the reduced object forms 438. In an example, the enroll data may be or include the enroll data 436. In an example, the first user may be the first user 1014 and the second user may be the second user 1016. In an example, 1506 may be performed by the reduced form provider 198. At 1510, the apparatus (e.g., an object library) transmits, to the first device and based on the query, a list of the supported forms of the enroll data. For example, FIG. 11 at 1116 shows that the object library 1104 may transmit, to the first device and based on the query, a list of the supported forms of the enroll data. In an example, the list may be or may be associated with the supported reduced form(s) 454. In an example, 1510 may be performed by the reduced form provider 198.

At 1512, the apparatus (e.g., an object library) receives, from the first device, an identifier of a supported form in the list of the supported forms. For example, FIG. 11 at 1122 shows that the object library 1104 may receive, from the first device, an identifier of a supported form in the list of the supported forms. In an example, the identifier of the supported form may be or may be associated with the selected reduced form 456. In an example, 1512 may be performed by the reduced form provider 198.

At 1518, the apparatus (e.g., an object library) transmits, to the first device, the supported form, where the supported form is associated with an avatar call between the first device and a second device of the second user. For example, FIG. 11 at 1124 shows that the object library 1104 may transmit, to the first device, the supported form, where the supported form is associated with an avatar call between the first device and a second device of the second user. In an example, the second device may be or include the second device 406, the second device 706, the second device 806, the second device 1010, or the second device 1106. In an example, 1518 may be performed by the reduced form provider 198.

In one aspect, the list of the supported forms of the enroll data may include at least one of a three-dimensional (3D) mesh, a normal map, an Albedo map, a specular map, or network weights. For example, the aforementioned aspect may correspond to the 3D meshes 422, the normal maps 426, the Albedo maps 428, the specular maps 430, the avatar network weights 432, or the digital twin network weights 434.

In one aspect, at 1508, the apparatus (e.g., an object library) may generate, based on the query, the list of the supported forms of the enroll data, where transmitting the list of the supported forms of the enroll data may include transmitting the generated list of the supported forms of the enroll data. For example, FIG. 11 at 1114 shows that the object library 1104 may generate, based on the query, the list of the supported forms of the enroll data, where transmitting the list of the supported forms of the enroll data at 1116 may include transmitting the generated list of the supported forms of the enroll data. In an example, 1508 may be performed by the reduced form provider 198.

In one aspect, the object library may include a first cache at the first device or a second cache at a server. For example, the first cache may be the cache 906 and the first device may be the end device 908. In another example, the second cache may be the cache 914 and the server may be the server 916.

In one aspect, at 1502, the apparatus (e.g., an object library) may establish a first session between the object library and the first device, where receiving the query may include receiving the query during the first session, and where transmitting the list of the supported forms may include transmitting the list of the supported forms during the first session. For example, FIG. 11 at 1108 shows that the object library 1104 may establish a first session between the object library and the first device, where receiving the query at 1112 may include receiving the query during the first session, and where transmitting the list of the supported forms at 1116 may include transmitting the list of the supported forms during the first session. In an example, the first session may be the second session 414. In an example, 1502 may be performed by the reduced form provider 198.

In one aspect, at 1504, the apparatus (e.g., an object library) may receive, from the first device, information associated with the second device. For example, FIG. 11 at 1128 shows that the object library 1104 may receive, from the first device, information associated with the second device. In an example, the aforementioned aspect may correspond to 826 in FIG. 8. In an example, 1504 may be performed by the reduced form provider 198.

In one aspect, at 1514, the apparatus (e.g., an object library) may establish a second session between the object library and the second device based on the information associated with the second device. For example, FIG. 11 at 1132 shows that the object library 1104 may establish a second session between the object library and the second device based on the information associated with the second device. In an example, the aforementioned aspect may correspond to 828 in FIG. 8. In an example, 1514 may be performed by the reduced form provider 198.

In one aspect, at 1516, the apparatus (e.g., an object library) may transmit, to the second device, the supported form. For example, FIG. 11 at 1134 shows that the object library 1104 may transmit, to the second device, the supported form. In an example, 1516 may be performed by the reduced form provider 198.

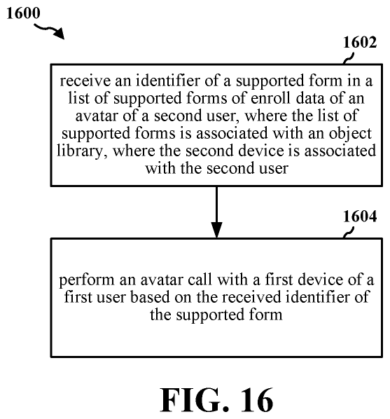

FIG. 16 is a flowchart 1600 of an example method of graphics processing in accordance with one or more techniques of this disclosure. The method may be performed by an apparatus, such as an apparatus for graphics processing, a GPU, a CPU, the device 104, the second device 406, the second device 706, the second device 806, the second device 1010, the second device 1106, a wireless communication device, and the like, as used in connection with the aspects of FIGS. 1-11. In an example, the method may be performed by the reduced form provider 199.

At 1602, the apparatus (e.g., a second device) receives an identifier of a supported form in a list of supported forms of enroll data of an avatar of a second user, where the list of supported forms is associated with an object library, where the second device is associated with the second user. For example, FIG. 11 at 1120 shows that the second device 1106 may receive an identifier of a supported form in a list of supported forms of enroll data of an avatar of a second user, where the list of supported forms is associated with an object library, where the second device is associated with the second user. In an example, the identifier of the supported form may correspond to the selected reduced form 456. In an example, the second user may be the second user 1016. In an example, the list of supported forms may correspond to the supported reduced form(s) 454. In an example, the object library may be or include the object library 416, the object library 704, the object library 804, the end device 908, the server 916, the first device 1004, or the object library 1104. In an example, 1602 may be performed by the reduced form provider 199.

At 1604, the apparatus (e.g., a second device) performs an avatar call with a first device of a first user based on the received identifier of the supported form. For example, FIG. 11 at 1136 shows that the second device 1106 may perform an avatar call with a first device of a first user based on the received identifier of the supported form. In an example, the first device may be or include the first device may be or include the first device 404, the first device 702, the first device 802, the first device 1004, or the first device 1102. In an example, the first user may be the first user 1014. In an example, 1604 may be performed by the reduced form provider 199.

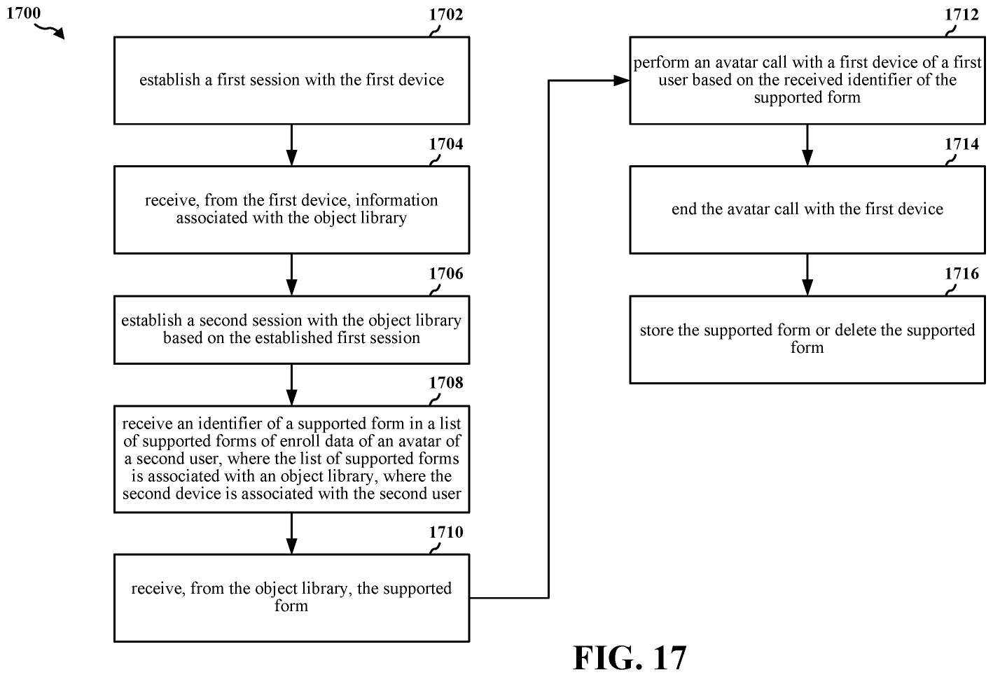

FIG. 17 is a flowchart 1700 of an example method of graphics processing in accordance with one or more techniques of this disclosure. The method may be performed by an apparatus, such as an apparatus for graphics processing, a GPU, a

CPU, the device 104, the second device 406, the second device 706, the second device 806, the second device 1010, the second device 1106, a wireless communication device, and the like, as used in connection with the aspects of FIGS. 1-11. In an example, the method (including the various aspects detailed below) may be performed by the reduced form provider 199.

At 1708, the apparatus (e.g., a second device) receives an identifier of a supported form in a list of supported forms of enroll data of an avatar of a second user, where the list of supported forms is associated with an object library, where the second device is associated with the second user. For example, FIG. 11 at 1120 shows that the second device 1106 may receive an identifier of a supported form in a list of supported forms of enroll data of an avatar of a second user, where the list of supported forms is associated with an object library, where the second device is associated with the second user. In an example, the identifier of the supported form may correspond to the selected reduced form 456. In an example, the second user may be the second user 1016. In an example, the list of supported forms may correspond to the supported reduced form(s) 454. In an example, the object library may be or include the object library 416, the object library 704, the object library 804, the end device 908, the server 916, the first device 1004, or the object library 1104. In an example, 1708 may be performed by the reduced form provider 199.

At 1712, the apparatus (e.g., a second device) performs an avatar call with a first device of a first user based on the received identifier of the supported form. For example, FIG. 11 at 1136 shows that the second device 1106 may perform an avatar call with a first device of a first user based on the received identifier of the supported form. In an example, the first device may be or include the first device may be or include the first device 404, the first device 702, the first device 802, the first device 1004, or the first device 1102. In an example, the first user may be the first user 1014. In an example, 1712 may be performed by the reduced form provider 199.

In one aspect, the list of the supported forms of the enroll data may include at least one of a three-dimensional (3D) mesh, a normal map, an Albedo map, a specular map, or network weights. For example, the aforementioned aspect may correspond to the 3D meshes 422, the normal maps 426, the Albedo maps 428, the specular maps 430, the avatar network weights 432, or the digital twin network weights 434.

In one aspect, receiving the identifier of the supported form may include receiving, from the object library, the identifier of the supported form. For example, the aforementioned aspect may correspond to 830 in FIG. 8.

In one aspect, receiving the identifier of the supported form may include receiving, from the first device, the identifier of the supported form. For example, the aforementioned aspect may correspond to 1120 in FIG. 11.

In one aspect, at 1710, the apparatus (e.g., a second device) may receive, from the object library, the supported form, where performing the avatar call with the first device may include performing the avatar call further based on the supported form. For example, FIG. 11 at 1134 shows that the second device 1106 may receive, from the object library, the supported form, where performing the avatar call with the first device at 1136 may include performing the avatar call further based on the supported form. In an example, 1710 may be performed by the reduced form provider 199.

In one aspect, at 1714, the apparatus (e.g., a second device) may end the avatar call with the first device. For example, FIG. 11 at 1142 shows that the second device 1106 may end the avatar call with the first device. In an example, 1714 may be performed by the reduced form provider 199.

In one aspect, at 1716, the apparatus (e.g., a second device) may store the supported form or delete the supported form. For example, FIG. 11 at 1144 shows that the second device 1106 may store the supported form or delete the supported form. In an example, 1716 may be performed by the reduced form provider 199.

In one aspect, at 1702, the apparatus (e.g., a second device) may establish a first session with the first device. For example, FIG. 11 at 1110 shows that the second device 1106 may establish a first session with the first device. In an example, 1702 may be performed by the reduced form provider 199.

In one aspect, at 1706, the apparatus (e.g., a second device) may establish a second session with the object library based on the established first session, where performing the avatar call with the first device may include performing the avatar call during the second session. For example, FIG. 11 at 1132 shows that the second device 1106 may establish a second session with the object library based on the established first session, where performing the avatar call with the first device at 1136 may include performing the avatar call during the second session. In an example, 1706 may be performed by the reduced form provider 199.

In one aspect, at 1704, the apparatus (e.g., a second device) may receive, from the first device, information associated with the object library, where establishing the second session may include establishing the second session further based on the received information. For example, FIG. 11 at 1130 shows that the second device 1106 may receive, from the first device, information associated with the object library, where establishing the second session at 1132 may include establishing the second session further based on the received information. In an example, 1704 may be performed by the reduced form provider 199.

In one aspect, the object library may include a first cache at the first device or a second cache at a server. For example, the first cache may be the cache 906 and the first device may be the end device 908. In another example, the second cache may be the cache 914 and the server may be the server 916.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for transmitting, to an object library, a query for supported forms of enroll data of an avatar of a second user, where the first device is associated with a first user and a second device is associated with the second user. The apparatus may further include means for receiving, from the object library and based on the query, a list of the supported forms of the enroll data. The apparatus may further include means for transmitting, to the second device, an identifier of a supported form in the list of the supported forms. The apparatus may further include means for performing an avatar call with the second device based on the transmitted identifier of the supported form. The apparatus may further include means for selecting the identifier of the supported form after the reception of the list of the supported forms, where transmitting the identifier of the supported form includes transmitting the selected identifier of the supported form. The apparatus may further include means for transmitting, to the object library, the selected identifier of the supported form. The apparatus may further include means for receiving, from the object library, the supported form, where performing the avatar call includes performing the avatar call based on the received supported form. The apparatus may further include means for ending the avatar call with the second device. The apparatus may further include means for storing the supported form or deleting the supported form. The apparatus may further include means for establishing a first session with the object library, where transmitting the query includes transmitting the query during the first session, and where receiving the list of the supported forms includes receiving the list of the supported forms during the first session. The apparatus may further include means for establishing a second session with the second device, where transmitting the identifier of the supported form includes transmitting the identifier of the supported form during the second session, and where performing the avatar call with the second device includes performing the avatar call with the second device during the second session. The apparatus may further include means for receiving, from the second device and based on the identifier of the supported form, a set of mesh animation parameters for the avatar of the second user, where performing the avatar call includes animating the avatar of the second user based on the set of mesh animation parameters. The apparatus may further include means for transmitting, to the object library, information associated with the second device, where performing the avatar call with the second device is further based on the transmitted information associated with the second device.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for receiving, from a first device of a first user, a query for supported forms of enroll data of an avatar of a second user. The apparatus may further include means for transmitting, to the first device and based on the query, a list of the supported forms of the enroll data. The apparatus may further include means for receiving, from the first device, an identifier of a supported form in the list of the supported forms. The apparatus may further include means for transmitting, to the first device, the supported form, where the supported form is associated with an avatar call between the first device and a second device of the second user. The apparatus may further include means for generating, based on the query, the list of the supported forms of the enroll data, where transmitting the list of the supported forms of the enroll data includes transmitting the generated list of the supported forms of the enroll data. The apparatus may further include means for establishing a first session between the object library and the first device, where receiving the query includes receiving the query during the first session, and where transmitting the list of the supported forms includes transmitting the list of the supported forms during the first session. The apparatus may further include means for receiving, from the first device, information associated with the second device. The apparatus may further include means for establishing a second session between the object library and the second device based on the information associated with the second device. The apparatus may further include means for transmitting, to the second device, the supported form.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for receiving an identifier of a supported form in a list of supported forms of enroll data of an avatar of a second user, where the list of supported forms is associated with an object library, where the second device is associated with the second user. The apparatus may further include means performing an avatar call with a first device of a first user based on the received identifier of the supported form. The apparatus may further include means for receiving, from the object library, the supported form, where performing the avatar call with the first device includes performing the avatar call further based on the supported form. The apparatus may further include means for ending the avatar call with the first device. The apparatus may further include means for storing the supported form or deleting the supported form. The apparatus may further include means for establishing a first session with the first device. The apparatus may further include means for establishing a second session with the object library based on the established first session, where performing the avatar call with the first device includes performing the avatar call during the second session. The apparatus may further include means for receiving, from the first device, information associated with the object library, where establishing the second session includes establishing the second session further based on the received information.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 a method of graphics processing at a first device, including, transmitting, to an object library, a query for supported forms of enroll data of an avatar of a second user, wherein the first device is associated with a first user and a second device is associated with the second user; receiving, from the object library and based on the query, a list of the supported forms of the enroll data; transmitting, to the second device, an identifier of a supported form in the list of the supported forms; and performing an avatar call with the second device based on the transmitted identifier of the supported form.

Aspect 2 may be combined with aspect 1, wherein the list of the supported forms of the enroll data include at least one of a three-dimensional (3D) mesh, a normal map, an Albedo map, a specular map, or network weights.

Aspect 3 may be combined with any of aspects 1-2, further including: selecting the identifier of the supported form after the reception of the list of the supported forms, wherein transmitting the identifier of the supported form includes transmitting the selected identifier of the supported form; transmitting, to the object library, the selected identifier of the supported form; and receiving, from the object library, the supported form, wherein performing the avatar call includes performing the avatar call based on the received supported form.

Aspect 4 may be combined with aspect 3, further including: ending the avatar call with the second device; and storing the supported form or deleting the supported form.

Aspect 5 may be combined with any of aspects 1-4, wherein the object library includes a first cache at the first device or second cache at a server.

Aspect 6 may be combined with any of aspects 1-5, wherein performing the avatar call with the second device includes displaying the avatar of the second user on a display of the first device.

Aspect 7 may be combined with any of aspects 1-6, further including: establishing a first session with the object library, wherein transmitting the query includes transmitting the query during the first session, and wherein receiving the list of the supported forms includes receiving the list of the supported forms during the first session; and establishing a second session with the second device, wherein transmitting the identifier of the supported form includes transmitting the identifier of the supported form during the second session, and wherein performing the avatar call with the second device includes performing the avatar call with the second device during the second session.

Aspect 8 may be combined with any of aspects 1-7, further including: receiving, from the second device and based on the identifier of the supported form, a set of mesh animation parameters for the avatar of the second user, wherein performing the avatar call includes animating the avatar of the second user based on the set of mesh animation parameters.

Aspect 9 may be combined with any of aspects 1-8, further including: transmitting, to the object library, information associated with the second device, wherein performing the avatar call with the second device is further based on the transmitted information associated with the second device.

Aspect 10 is an apparatus for graphics processing including a memory and a processor coupled to the memory and, based on information stored in the memory, the processor is configured to implement a method as in any of aspects 1-9.

Aspect 11 may be combined with aspect 10 and includes that the apparatus is a wireless communication device comprising at least one of a transceiver or an antenna coupled to the processor, wherein to transmit the query, the processor is configured to transmit the query via at least one of the transceiver or the antenna.

Aspect 12 is an apparatus for graphics processing including means for implementing a method as in any of aspects 1-9.

Aspect 13 is a computer-readable medium (e.g., a non-transitory computer-readable medium) storing computer executable code, the computer executable code, when executed by a processor, causes the processor to implement a method as in any of aspects 1-9.

Aspect 14 is a method of graphics processing at an object library, including: receiving, from a first device of a first user, a query for supported forms of enroll data of an avatar of a second user; transmitting, to the first device and based on the query, a list of the supported forms of the enroll data; receiving, from the first device, an identifier of a supported form in the list of the supported forms; and transmitting, to the first device, the supported form, wherein the supported form is associated with an avatar call between the first device and a second device of the second user.

Aspect 15 may be combined with aspect 14, wherein the list of the supported forms of the enroll data include at least one of a three-dimensional (3D) mesh, a normal map, an Albedo map, a specular map, or network weights.

Aspect 16 may be combined with any of aspects 14-15, further including: generating, based on the query, the list of the supported forms of the enroll data, wherein transmitting the list of the supported forms of the enroll data includes transmitting the generated list of the supported forms of the enroll data.

Aspect 17 may be combined with any of aspects 14-16, wherein the object library includes a first cache at the first device or a second cache at a server.

Aspect 18 may be combined with any of aspects 14-17, further including: establishing a first session between the object library and the first device, wherein receiving the query includes receiving the query during the first session, and wherein transmitting the list of the supported forms includes transmitting the list of the supported forms during the first session.

Aspect 19 may be combined with aspect 18, further including: receiving, from the first device, information associated with the second device; establishing a second session between the object library and the second device based on the information associated with the second device; and transmitting, to the second device, the supported form.

Aspect 20 is an apparatus for graphics processing including a memory and a processor coupled to the memory and, based on information stored in the memory, the processor is configured to implement a method as in any of aspects 14-19.

Aspect 21 may be combined with aspect 20 and includes that the apparatus is a wireless communication device comprising at least one of a transceiver or an antenna coupled to the processor, wherein to receive the query, the processor is configured to receive the query via at least one of the transceiver or the antenna.

Aspect 22 is an apparatus for graphics processing including means for implementing a method as in any of aspects 14-19.

Aspect 23 is a computer-readable medium (e.g., a non-transitory computer-readable medium) storing computer executable code, the computer executable code, when executed by a processor, causes the processor to implement a method as in any of aspects 14-19.

Aspect 24 is a method of graphics processing at a second device, including: receiving an identifier of a supported form in a list of supported forms of enroll data of an avatar of a second user, wherein the list of supported forms is associated with an object library, wherein the second device is associated with the second user; and performing an avatar call with a first device of a first user based on the received identifier of the supported form.

Aspect 25 may be combined with aspect 24, wherein the list of the supported forms of the enroll data include at least one of a three-dimensional (3D) mesh, a normal map, an Albedo map, a specular map, or network weights.

Aspect 26 may be combined with any of aspects 24-25, wherein receiving the identifier of the supported form includes receiving, from the object library, the identifier of the supported form.

Aspect 27 may be combined with any of aspects 24-26, wherein receiving the identifier of the supported form includes receiving, from the first device, the identifier of the supported form.

Aspect 28 may be combined with any of aspects 24-27, further including: receiving, from the object library, the supported form, wherein performing the avatar call with the first device includes performing the avatar call further based on the supported form.

Aspect 29 may be combined with aspect 28, further including: ending the avatar call with the first device; and storing the supported form or deleting the supported form.

Aspect 30 may be combined with any of aspects 24-29, further including: establishing a first session with the first device; and establishing a second session with the object library based on the established first session, wherein performing the avatar call with the first device includes performing the avatar call during the second session.

Aspect 31 may be combined with aspect 30, further including: receiving, from the first device, information associated with the object library, wherein establishing the second session includes establishing the second session further based on the received information.

Aspect 32 may be combined with any of aspects 24-31, wherein the object library includes a first cache at the first device or a second cache at a server.

Aspect 33 is an apparatus for graphics processing including a memory and a processor coupled to the memory and, based on information stored in the memory, the processor is configured to implement a method as in any of aspects 24-32.

Aspect 34 may be combined with aspect 33 and includes that the apparatus is a wireless communication device comprising at least one of a transceiver or an antenna coupled to the processor, wherein to receive the identifier of the supported form, the processor is configured to receive the identifier of the supported form via at least one of the transceiver or the antenna.

Aspect 35 is an apparatus for graphics processing including means for implementing a method as in any of aspects 24-32.

Aspect 36 is a computer-readable medium (e.g., a non-transitory computer-readable medium) storing computer executable code, the computer executable code, when executed by a processor, causes the processor to implement a method as in any of aspects 24-32.

Various aspects have been described herein. These and other aspects are within the scope of the following claims.

What is claimed is:

1. An apparatus for graphics processing at a first device, comprising:
a memory; and
a processor coupled to the memory and, based on information stored in the memory, the processor is configured to:
transmit, to an object library, a query for supported forms of enroll data of an avatar of a second user, wherein the first device is associated with a first user and a second device is associated with the second user;
receive, from the object library and based on the query, a list of the supported forms of the enroll data;
transmit, to the second device, an identifier of a supported form in the list of the supported forms; and
perform an avatar call with the second device based on the transmitted identifier of the supported form.

2. The apparatus of claim 1, wherein the list of the supported forms of the enroll data comprise at least one of a three-dimensional (3D) mesh, a normal map, an Albedo map, a specular map, or network weights.

3. The apparatus of claim 1, wherein the processor is further configured to:
select the identifier of the supported form after the reception of the list of the supported forms, wherein to transmit the identifier of the supported form, the processor is configured to transmit the selected identifier of the supported form;
transmit, to the object library, the selected identifier of the supported form; and
receive, from the object library, the supported form, wherein to perform the avatar call, the processor is configured to perform the avatar call based on the received supported form.

4. The apparatus of claim 3, wherein the processor is further configured to:
end the avatar call with the second device; and
store the supported form or delete the supported form.

5. The apparatus of claim 1, wherein the object library comprises a first cache at the first device or second cache at a server.

6. The apparatus of claim 1, wherein to perform the avatar call with the second device, the processor is configured to display the avatar of the second user on a display of the first device.

7. The apparatus of claim 1, wherein the processor is further configured to:
establish a first session with the object library, wherein to transmit the query, the processor is configured to transmit the query during the first session, and wherein to receive the list of the supported forms, the processor is configured to receive the list of the supported forms during the first session; and
establish a second session with the second device, wherein to transmit the identifier of the supported form, the processor is configured to transmit the identifier of the supported form during the second session, and wherein to perform the avatar call with the second device, the processor is configured to perform the avatar call with the second device during the second session.

8. The apparatus of claim 1, wherein the processor is further configured to:
receive, from the second device and based on the identifier of the supported form, a set of mesh animation parameters for the avatar of the second user, wherein to perform the avatar call, the processor is configured to animate the avatar of the second user based on the set of mesh animation parameters.

9. The apparatus of claim 1, wherein the processor is further configured to:
transmit, to the object library, information associated with the second device, wherein to perform the avatar call with the second device, the processor is configured to perform the avatar call with the second device further based on the transmitted information associated with the second device.

10. The apparatus of claim 1, wherein the apparatus is a wireless communication device comprising at least one of a transceiver or an antenna coupled to the processor, and wherein to transmit the query, the processor is configured to transmit the query via at least one of the transceiver or the antenna.

11. An apparatus for graphics processing at an object library, comprising:
a memory; and
a processor coupled to the memory and, based on information stored in the memory, the processor is configured to:
receive, from a first device of a first user, a query for supported forms of enroll data of an avatar of a second user;
transmit, to the first device and based on the query, a list of the supported forms of the enroll data;
receive, from the first device, an identifier of a supported form in the list of the supported forms; and
transmit, to the first device, the supported form, wherein the supported form is associated with an avatar call between the first device and a second device of the second user.

12. The apparatus of claim 11, wherein the list of the supported forms of the enroll data comprise at least one of a three-dimensional (3D) mesh, a normal map, an Albedo map, a specular map, or network weights.

13. The apparatus of claim 11, wherein the processor is further configured to:
generate, based on the query, the list of the supported forms of the enroll data, wherein to transmit the list of the supported forms of the enroll data, the processor is configured to transmit the generated list of the supported forms of the enroll data.

14. The apparatus of claim 11, wherein the object library comprises a first cache at the first device or a second cache at a server.

15. The apparatus of claim 11, wherein the processor is further configured to:
establish a first session between the object library and the first device, wherein to receive the query, the processor is configured to receive the query during the first session, and wherein to transmit the list of the supported forms, the processor is configured to transmit the list of the supported forms during the first session.

16. The apparatus of claim 15, wherein the processor is further configured to:
receive, from the first device, information associated with the second device;
establish a second session between the object library and the second device based on the information associated with the second device; and
transmit, to the second device, the supported form.

17. The apparatus of claim 11, wherein the apparatus is a wireless communication device comprising at least one of a transceiver or an antenna coupled to the processor, and wherein to receive the query, the processor is configured to receive the query via at least one of the transceiver or the antenna.

18. An apparatus for graphics processing at a second device, comprising:
a memory; and
a processor coupled to the memory and, based on information stored in the memory, the processor is configured to:
receive an identifier of a supported form in a list of supported forms of enroll data of an avatar of a second user, wherein the list of supported forms is associated with an object library, wherein the second device is associated with the second user; and
perform an avatar call with a first device of a first user based on the received identifier of the supported form.

19. The apparatus of claim 18, wherein the list of the supported forms of the enroll data comprise at least one of a three-dimensional (3D) mesh, a normal map, an Albedo map, a specular map, or network weights.

20. The apparatus of claim 18, wherein to receive the identifier of the supported form, the processor is configured to receive, from the object library, the identifier of the supported form.

21. The apparatus of claim 18, wherein to receive the identifier of the supported form, the processor is configured to receive, from the first device, the identifier of the supported form.

22. The apparatus of claim 18, wherein the processor is further configured to:
receive, from the object library, the supported form, wherein to perform the avatar call with the first device, the processor is configured to perform the avatar call further based on the supported form.

23. The apparatus of claim 22, wherein the processor is further configured to:
end the avatar call with the first device; and
store the supported form or delete the supported form.

24. The apparatus of claim 18, wherein the processor is further configured to:
establish a first session with the first device; and
establish a second session with the object library based on the established first session, wherein to perform the avatar call with the first device, the processor is configured to perform the avatar call during the second session.

25. The apparatus of claim 24, wherein the processor is further configured to:
receive, from the first device, information associated with the object library, wherein to establish the second session, the processor is configured to establish the second session further based on the received information.

26. The apparatus of claim 18, wherein the object library comprises a first cache at the first device or a second cache at a server.

27. The apparatus of claim 18, wherein the apparatus is a wireless communication device comprising at least one of a transceiver or an antenna coupled to the processor, and wherein to receive the identifier of the supported form, the processor is configured to receive the identifier of the supported form via at least one of the transceiver or the antenna.

28. A method of graphics processing at a first device, comprising,
transmitting, to an object library, a query for supported forms of enroll data of an avatar of a second user, wherein the first device is associated with a first user and a second device is associated with the second user;
receiving, from the object library and based on the query, a list of the supported forms of the enroll data;
transmitting, to the second device, an identifier of a supported form in the list of the supported forms; and
performing an avatar call with the second device based on the transmitted identifier of the supported form.

29. The method of claim 28, wherein the list of the supported forms of the enroll data comprise at least one of a three-dimensional (3D) mesh, a normal map, an Albedo map, a specular map, or network weights.

30. The method of claim 28, further comprising:
selecting the identifier of the supported form after the reception of the list of the supported forms, wherein transmitting the identifier of the supported form comprises transmitting the selected identifier of the supported form;
transmitting, to the object library, the selected identifier of the supported form; and
receiving, from the object library, the supported form, wherein performing the avatar call comprises performing the avatar call based on the received supported form.
